(19) United States
(12) Patent Application Publication
(10) Pub. No.: US 2022/0278892 A1
(43) Pub. Date: Sep. 1, 2022

(54) DEVICE AND METHOD FOR CONTROLLING COMMUNICATION OF INFORMATION

(71) Applicant: Lenovo (Singapore) Pte. Ltd., New Tech Park (SG)

(72) Inventors: Alden Dixon Rose, Durham, NC (US); Ellis Anderson, Greensboro, NC (US); Dhruvi Suresh Fulfagar, Greensboro, NC (US); Rebecca Megan Frankosky, Raleigh, NC (US); Aaron Michael Stewart, Raleigh, NC (US); Hallie Elizabeth Clark MacEldowney, Raleigh, NC (US)

(21) Appl. No.: 17/188,904

(22) Filed: Mar. 1, 2021

(51) Int. Cl. H04L 12/24; H04L 29/08

(52) U.S. Cl. CPC H04L 41/0803; H04L 67/12

(57) ABSTRACT

An electronic device is provided that includes a housing that has a sensor mounting panel, and first and second sensors mounted in the housing and oriented to extend through the sensor mounting panel to face an environment of interest. The electronic device is operable to change an operating state, of the first sensor, between first, second and third operating states. The first operating state represents a network sharing state in which the first type of information collected by the first sensor is shared with the network resource through the communications interface. The second operating state represents a local state in which the first type of information is maintained locally on, and is solely accessible to, the one or more processors of the electronic device and is not shared with the network resource.

### BACKGROUND

Embodiments herein generally relate to devices and methods for controlling communication of information.

Electronic devices, such as laptop computers, mobile phones, personal digital assistants (PDAs), iPads, other computing devices, etc. have become part of many individuals' everyday life. Such electronic devices continue to be improved to make the experience of user as enjoyable as possible.

Artificial intelligence (AI) is becoming common place for use in association with electronic devices. Whether to assist in making choices for an individual while shopping, customizing use, or just recognizing different individuals, AI is becoming more prominent in day to day settings. AI applications include AI algorithms that attempt to utilize numerous variables based on information received to make determinations regarding choices that are to be made. The AI algorithms utilize initial assumptions to determine the variables; however, as individuals make choices, the variables are modified to reflect an individual's choice. As a result, the more information that an AI application has, the more effective the AI application can become at making correct choices. Specifically, AI systems work better with a more complete data set.

Though AI is meant to provide more enjoyment and functionality for an individual using an electronic device, users often are skeptical of sharing the information required that is utilized by AI for improving the experience of the user. In particular, with cybercrimes, spamming, identity theft, etc. users often do not trust sharing personal information with third parties. Specifically, there is a general lack of trust and control associated with AI and “smart devices” by users. As devices begin to carry more embedded sensors, and these sensors collect and process richer data sets, often involving personal information, users need a way to feel comfortable using these sensors.

Still, current electronic devices do not provide the comfort level desired by users. For example, current sensor controls on a laptop consist of hardware shutters over the top of sensors, hardware kill-switches on the laptop, and minimal software controls embedded in the system controls, or in an application. Such hardware and software are limited in controlling the information that may be obtained by the sensors.

### SUMMARY

In accordance with embodiments herein, an electronic device is provided that includes an output to present audio/video (AV) content, a memory to store executable instructions, and a communications interface configured to communicate with a network resource. The electronic device also includes a housing that has a sensor mounting panel, and first and second sensors mounted in the housing and oriented to extend through the sensor mounting panel to face an environment of interest. The first sensor is operable to collect a first type of information regarding the environment of interest. Similarly, the second sensor is operable to collect a second type of information that is different from the first type of information regarding the environment of interest. The electronic device also includes one or more processors, that when implementing the executable instructions change an operating state, of the first sensor, between first, second and third operating states. The first operating state represents a network sharing state in which the first type of information collected by the first sensor is shared with the network resource through the communications interface. The second operating state represents a local state in which the first type of information is maintained locally on, and is solely accessible to, the one or more processors of the electronic device and is not shared with the network resource.

Optionally, the one or more processors are further configured to identify a condition present in the environment of interest based on the first type of information and the second type of information. In one aspect, the memory is further configured to store first and second profiles that define corresponding combinations of operating states associated with potential conditions that may become present in the environment of interest. The one or more processors are also further configured to select either the first profile or second provide based on the potential conditions. In another aspect, the one or more processors are further configured to switch between the first profile and second profile based on the condition present in the environment identified.

Optionally, at least one of the first sensor or the second sensor operates in the first operating state and the second operating state. In one aspect, the electronic device also includes status indicators provided on the housing, the status indicators to designate the operating state of the first and second sensors. In one example, the status indicators include a light element that indicates the operating state of the first and second sensors. In another aspect, the condition present in the environment of interest is at least one of a first condition detected by the first sensor that is an image sensor, a launching of an application, or a second condition detected by the second sensor that is a microphone. In one embodiment, the one or more processors are further configured to display on the output a control resource, and determine the operating state based on a user input to the control resource.

Optionally, the electronic device also includes a shutter coupled to the housing and configured to move from a first position that covers the first and second sensors to a second position that uncovers the first and second sensors. In one aspect, the one or more processors are further configured to deactivate the first and second sensors when the shutter is placed in the first position, and activate the first and second sensors when the shutter is placed in the second position.

In accordance with embodiments herein, a method is provided where under the control of one or more processors including program instructions, the method includes obtaining, with a first sensor, a first type of information regarding an environment of interest. The method also includes obtaining, with a second sensor, a second type of information regarding the environment of interest that is different than the first type of information. The one or more processors also change an operating state, of the first sensor, between first, second and third operating states based on the first type of information and the second type of information obtained. The first operating state represents a network sharing state in which the first type of information obtained by the first sensor is shared with the network resource through the communications interface. The second operating state represents a local state in which the first type of information is maintained locally on, and is solely accessible to, the one or more processors of the electronic device and is not shared with the network resource. The third operating state represents a private state where first type of information is not shared with the network resource or maintained locally on the one or more processors.

Optionally, the one or more processors also include program instructions to identify a condition present in the environment of interest based on the first type of information and the second type of information. In one aspect, the one or more processors also include program instructions to select a first profile or second profile based on the condition. Meanwhile, the first profile and the second profile define corresponding combinations of operating states associated with potential conditions that may become present in the environment of interest, In another aspect, the one or more processors also include program instructions to switch between the first profile and second profile based on the condition present in the environment identified.

Optionally, the one or more processors also include program instructions to operate at least one of the first sensor or the second sensor in the first operating state and the second operating state. Optionally, the one or more processors also include program instructions to move a shutter from a first position that covers the first sensor and the second sensor, to a second position that uncovers the first sensor and the second sensor, deactivate the first sensor and the second sensor when the shutter is in the first position, and activate the first sensor and the second sensor when the shutter is in the second position.

In accordance with embodiments herein a sensor device is provided that include a housing that has a sensor mounting panel. The sensor device also has first and second sensors mounted in the housing and oriented to extend through the sensor mounting panel to face an environment of interest, the first sensor to collect a first type of information and the second sensor to collect a second type of information that is different from the first type of information, regarding the environment of interest. The sensor device also includes sensor control circuitry that changes a current operating state, of the first sensor, between first, second and third operating states. The first operating state represents a network sharing state in which the first type of information collected by the first sensor is shared with a separate network resource. The second operating state representing a local state in which the first type of information is maintained locally on, and is solely accessible to, the electronic device and is not shared with the separate network resource.

Optionally, the sensor also includes status indicators provided on the housing, the status indicators to designate a current operating state of the first sensor and the second sensor. In another aspect, the sensor device also includes a shutter coupled to the housing and configured to move from a first position that covers the first and second sensors to a second position that uncovers the first and second sensors.

### BRIEF DESCRIPTION OF THE DRAWINGS

FIG. 1 illustrates a schematic block diagram of a system for controlling communications, in accordance with embodiments herein.

FIG. 2 illustrates a schematic block diagram of an electronic device, in accordance with embodiments herein.

FIG. 3 illustrates a block diagram of a process for controlling communication of information, in accordance with embodiments herein.

FIG. 4 illustrates a front perspective view of an electronic device, in accordance with embodiments herein.

FIG. 5 illustrates a front perspective view of an electronic device, in accordance with embodiments herein.

FIG. 6 illustrates a schematic block diagram of a sensor device, in accordance with embodiments herein.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment,” “in an embodiment” or the like in various places throughout this specification are not necessarily all referring to the same embodiment.

Furthermore, the described features, structures or characteristics may be combined in any suitable manner in one or more embodiments. In the following description, numerous specific details are provided to give a thorough understanding of the various embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

The phrase “solely accessible” shall mean that there is only one manner in which to access information. When utilized with respect to sensor information shared with one or more processors, only the processors can access information. In this manner, even if the one or more processors are in communication with a network or one or more network devices, the sensor does not direct signals or information to the network, and the one or more processors do not communicate sensor based information to the network. To this end, the one or more processors prevent the sensor information from being shared with the network, even in instances when a network device requests such sensor information.

The phrase “maintained locally on” shall mean only provided on an electronic device. With reference to signals, information, data, etc. each is kept in one or more processors, a memory, circuitry, or the like of an electronic device. In this manner, the signals, information, data, etc. are not provided to a network, communicated over a wire, wirelessly, or the like to a network, cloud, remote electronic device, or the like.

The terms “audio/video” and “AV” shall mean audio and/or video and shall include audio only, video only, or a combination of audio and video. For example, AV content may include 1) only audio content, with no video content 2) only video content, with no audio content, or 3) a combination of audio and video content. As another example, an AV output device may include a device to 1) output only audio content, and not video content, 2) output only video content, and not audio content, or 3) output a combination of audio and video content. As another example, an AV source may represent 1) a source that provides audio content but does not provide video content, 2) a source that provides video content but does not provide audio content, or 3) a source that provides both audio and video content.

The term “environment” refers to a physical region in which one or more electronic devices and AV output devices are located and in which AV content output by the AV output device(s) is perceived (e.g., heard, seen, felt) by individuals. By way of example, an environment may refer to one or more rooms within a home, office or other structure. An environment may or may not have physical boundaries. For example, an environment instead be defined based upon a range over which individuals may perceive actions by electronic devices. When an electronic device is portable and/or handheld, an environment associated with the electronic device may shift over time when the electronic device is moved. For example, an environment surrounding a smart phone, tablet device or laptop computer moves with the smartphone, tablet device or laptop computer. An environment surrounding a electronic device will shift each time the electronic device is relocated, such as when moved between different rooms of a home, office building or other residential or commercial structure.

The term “network resource” refers to any device, system, controller, etc. that may monitor and communicate data and information that is related to an individual. Network resources can include servers, applications, remote processors, the cloud, etc. The network resource may communicate with an electronic device over a wire, through one or more wireless protocols including Bluetooth, GSM, infrared wireless LAN, HIPERLAN, 4G, 5G, satellite, or the like.

The term “operating state” refers to a state of operation of a device. Nonlimiting examples of operational states can include being “ON” and permitting communication of information or signals to one or more local processors and network resources, being “ON” and permitting communication of information or signals to only one or more local processors, being “ON” and permitting communication of information or signals to only network resources, being “OFF” such that no information or signals are communicated at all, and the like.

The term “obtains” and “obtaining”, as used in connection with data, signals, information and the like, include at least one of i) accessing memory of an external device or remote server where the data, signals, information, etc. are stored, ii) receiving the data, signals, information, etc. over a wireless communications link between the base device and a secondary device, and/or iii) receiving the data, signals, information, etc. at a remote server over a network connection. The obtaining operation, when from the perspective of a base device, may include sensing new signals in real time, and/or accessing memory to read stored data, signals, information, etc. from memory within the base device. The obtaining operation, when from the perspective of a secondary device, includes receiving the data, signals, information, etc. at a transceiver of the secondary device where the data, signals, information, etc. are transmitted from a base device and/or a remote server. The obtaining operation may be from the perspective of a remote server, such as when receiving the data, signals, information, etc. at a network interface from a local external device and/or directly from a base device. The remote server may also obtain the data, signals, information, etc. from local memory and/or from other memory, such as within a cloud storage environment and/or from the memory of a personal computer.

It should be clearly understood that the various arrangements and processes broadly described and illustrated with respect to the Figures, and/or one or more individual components or elements of such arrangements and/or one or more process operations associated of such processes, can be employed independently from or together with one or more other components, elements and/or process operations described and illustrated herein. Accordingly, while various arrangements and processes are broadly contemplated, described and illustrated herein, it should be understood that they are provided merely in illustrative and non-restrictive fashion, and furthermore can be regarded as but mere examples of possible working environments in which one or more arrangements or processes may function or operate.

A device and methods are provided for controlling information obtained by sensors of an electronic device. Two or more sensors are placed together in a similar location of an electronic device. In one example a first sensor and a second sensor are placed on a top bezel of a laptop screen. A shutter that is able to cover all of the sensors moves from a first position that allows the sensors to obtain information to a second position where the sensors are unable to obtain information. In this manner, the shutter acts as a software kill switch to turn the first sensor and the second sensor off. A capacitive strip is utilized over the top of the first sensor and second sensor to allow for direct manual control of the first sensor and the second sensor to provide different operating states of each of the first sensor and second sensor. In particular, multiple operating states for each of the first sensor and the second sensor are provided. For example, in a first operating state the first sensor shares information with network resources such as smart devices, applications, webpages, or the like that may include a network AI application. In the first operating state the first sensor also shares the information with the one or more processors of the electronic device, similarly for use with an AI application of the electronic device. In a second operating state, information may only be shared with the one or more processors of the electronic device, whereas in a third operating state, the first sensor does not share any information. In one example, the shutter is in a second position that covers the first sensor resulting in no information sharing occurring in the third operating state. Additionally, the electronic device also includes software utilized that is directly coupled to the first sensor and the second sensor to control the operating states of each of the first sensor and second sensor. In this manner, the software may control the communications instead of the physical shutter.

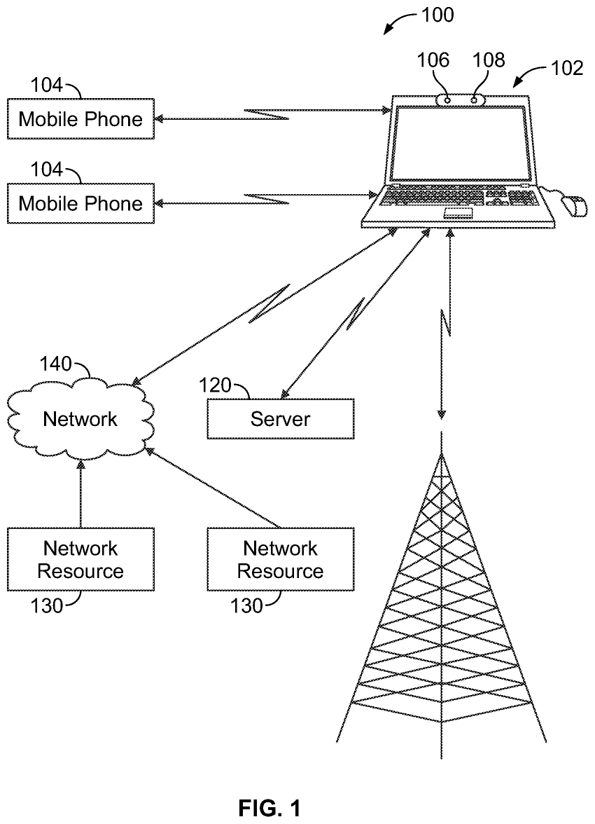

FIG. 1 is a block diagram of a system 100 for controlling communication of information, in accordance with embodiments herein. The system 100 includes an electronic device 102, one or more auxiliary electronic devices 104, and one or more servers 120. The electronic device 102 includes a first sensor 106 and a second sensor 108 that each obtain information related to user. The first sensor 104 and second sensor 106 are located in close proximity to one another and in one example are on a top bezel of the electronic device 102. The first sensor 106 and second sensor 108 may be beam-forming microphones, passive infrared sensors, time-of-flight, or LiDAR sensors, high-resolution red green blue (RGB) cameras, high-resolution RGB wide-angle camera, etc. While only a first sensor 104 and second sensor 106 are illustrated, in other examples three or more sensors are provided. In particular, the first sensor 104 obtains a first type of information, while the second sensor 106 obtains a second type of information. The first type of information in one example is auditory from a first sensor 104 that is a microphone, while the second type of information is visual from a second sensor 106 that is a camera. Similarly the first or second types of information can be infrared, haptic, or the like. Still, each of the first sensor 104 and second sensor 106 provide a different type of information that may be utilized by the one or more processors, an AI application, a network AI application, or the like.

By way of example, the electronic device 102 may be a mobile device, such as a cellular telephone, smartphone, tablet computer, personal digital assistant, laptop/desktop computer, gaming system, a media streaming hub device, IoT device, or other electronic terminal that includes a user interface and is configured to access a network 140 over a wired or wireless connection. As non-limiting examples, the electronic device 102 may access the network 140 through a wireless communications channel and/or through a network connection (e.g. the Internet). The electronic device 102 in one embodiment is in communication with a network resource 130 via the network. The network resource 130 can be a server, application, remote processor, the cloud, etc. In one example, the network resource 130 is one or more processors of an auxiliary electronic device 104 that communicates over the network 140 with the electronic device 102. The network 140 may represent one or more of a local area network (LAN), a wide area network (WAN), an Intranet or other private network that may not be accessible by the general public, or a global network, such as the Internet or other publicly accessible network.

Additionally or alternatively, the electronic device 102 may be a wired or wireless communication terminal, such as a desktop computer, laptop computer, network-ready television, set-top box, and the like. The electronic device 102 may be configured to access the network using a web browser or a native application executing thereon. In some embodiments, the electronic device 102 may have a physical size or form factor that enables it to be easily carried or transported by a user, or the primary electronic device 102 may have a larger physical size or form factor than a mobile device.

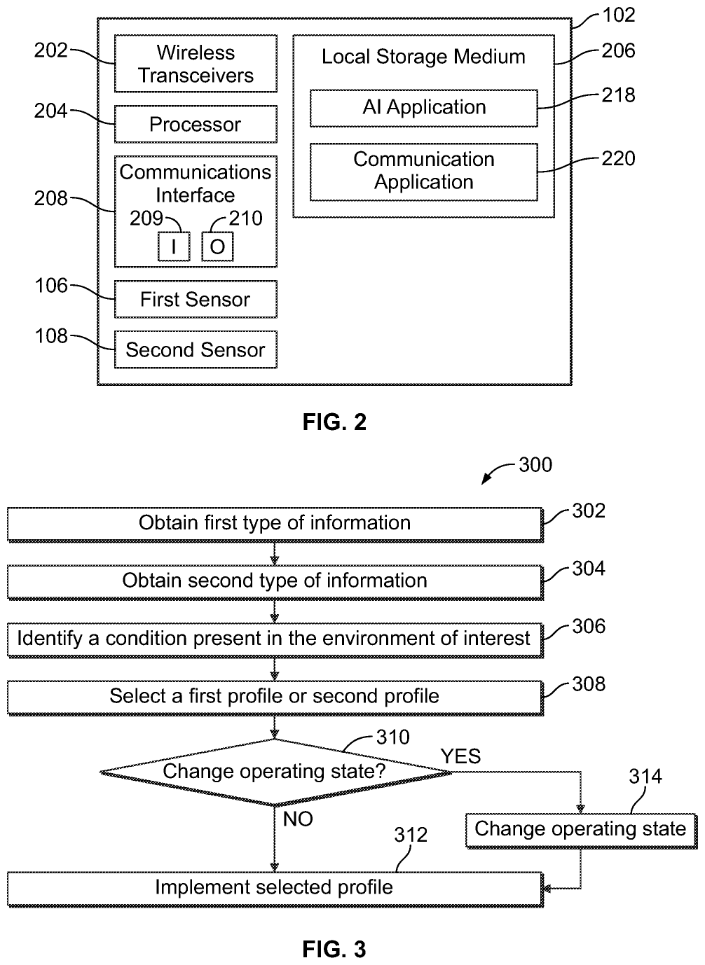

FIG. 2 illustrates a simplified block diagram of the electronic device 102 of FIG. 1 in accordance with an embodiment. The electronic device 102 includes components such as one or more wireless transceivers 202, one or more processors 204 (e.g., a microprocessor, microcomputer, application-specific integrated circuit, etc.), and one or more local storage medium (also referred to as a memory portion) 206.

Each transceiver 202 can utilize a known wireless technology for communication. Exemplary operation of the wireless transceivers 202 in conjunction with other components of the primary electronic device 102 may take a variety of forms and may include, for example, operation in which, upon reception of wireless signals, the components of primary electronic device 102 detect communication signals from auxiliary electronic devices 104 and the transceiver 202 demodulates the communication signals to recover incoming information, such as responses to inquiry requests, voice and/or data, transmitted by the wireless signals. The one or more processors 204 format outgoing information and convey the outgoing information to one or more of the wireless transceivers 202 for modulation to communication signals. The wireless transceiver(s) 202 convey the modulated signals to a remote device, such as a cell tower or a remote server (not shown).

The local storage medium 206 can encompass one or more memory devices of any of a variety of forms (e.g., read only memory, random access memory, static random access memory, dynamic random access memory, etc.) and can be used by the one or more processors 204 to store and retrieve data. The data that is stored by the local storage medium 206 can include, but need not be limited to, operating systems, applications, obtained context data, and informational data. Each operating system includes executable code that controls basic functions of the device, such as interaction among the various components, communication with external devices via the wireless transceivers 202, and storage and retrieval of applications and context data to and from the local storage medium 206.

The electronic device 102 in one embodiment also includes a communications interface 208 that is configured to communicate with a network resource (FIG. 1). The communications interface 208 can include one or more input devices 209 and one or more output devices 210. The input and output devices 209, 210 may each include a variety of visual, audio, and/or mechanical devices. For example, the input devices 209 can include a visual input device such as an optical sensor or camera, an audio input device such as a microphone, and a mechanical input device such as a keyboard, keypad, selection hard and/or soft buttons, switch, touchpad, touch screen, icons on a touch screen, a touch sensitive areas on a touch sensitive screen and/or any combination thereof. Similarly, the output devices 210 can include a visual output device such as a liquid crystal display screen, one or more status indicators that may be light elements such as light emitting diodes, an audio output device such as a speaker, alarm and/or buzzer, and a mechanical output device such as a vibrating mechanism. The display may be touch sensitive to various types of touch and gestures. As further examples, the output device(s) 210 may include a touch sensitive screen, a non-touch sensitive screen, a text-only display, a smart phone display, an audio output (e.g., a speaker or headphone jack), and/or any combination thereof.

The electronic device 102 also includes the first sensor 104, the second sensor 106, an artificial intelligence (AI) application 218, and communication application 220. All of these components can be operatively coupled to one another, and can be in communication with one another, by way of one or more internal communication links, such as an internal bus. The first sensor 104 and the second sensor 106 both function to obtain a first type of information and a second type of information related to the user or an environment of interest. The types of information can include visual, auditory, haptic, infrared, or the like. The information may include a first condition detected when the first sensor is an image sensor such as the presence of the user at the electronic device 102. Alternatively, the information may include a second condition detected when the second sensor is a microphone such as the determination that additional individuals are in an environment of the interest through voice recognition, the determination of spoken words, or the like. By obtaining information related to the environment of interest, the one or more processors 204 can determine a profile related to an individual in order to provide a setting for the first sensor 104 and second sensor 106. In particular, a profile may be related to an individual, including the operating settings for the first sensor 104 and second sensor 106 based on the conditions within the environment of interest. To this end, a first individual may have a first profile, while a second individual has a second profile. Alternatively, the first individual may have a first profile for when the individual is in their home compared to a second profile for when the individual is in an office. Similarly, in another example, a first individual can have a first profile that is typically utilized, and a second profile for when an application, such as a meeting application launches on the electronic device 102. As such, each profile has different settings for the first sensor 104 and second sensor 106 operating states.

The AI application 218 and the communication application 220 in one embodiment are stored within the storage medium 206 and each include executable code. Both the AI Application 218 and the communication application 220 obtain information from the first sensor 104, second sensor 106, along with other sensors, information input by a user, etc. For example, the AI application 218 may obtain the information related to the user and the environment of the user, or environment of interest, to make determinations about the use of the electronic device 102 to improve the experience of using the electronic device 102.

The communication application 220 in one example is accessed through the input device 209. In particular, the communication application 220 determines operating states of the first sensor 104, the second sensor 106, and any other sensor utilized by the electronic device 102. Specifically, the communication application 220 determines where information related to the first sensor 104 and second sensor 106 are communicated. For example, in one example, a first operating state of the first sensor is that information obtained by the first sensor 104 is shared with the one or more processors 204 and with network resources (FIG. 1). In one embodiment, the electronic device 102 is a laptop computer that is utilized by a family, and the first sensor 104 is a camera, and a father has a first profile while his daughter has a second profile. By having the one or more processors 204 obtaining information with the camera, the AI application can determine that the father of the family is utilizing the laptop, and the first profile is utilized such that common websites visited by the father can appear as icons when a web browser is opened. If the father finishes using the laptop, and a daughter begins using the laptop, again, the camera information can be utilized to determine the daughter is now using the laptop, and the second profile is utilized by the AI application to have icons appear that are common websites visited by the daughter.

Additionally, in an example when information is also communicated to network resources 130 (FIG. 1), a network resource can be a webpage that sells numerous items, or is an auction type webpage. The network resource 130 (FIG. 1) may also include a network AI application that attempts to customize and make the user's experience at the webpage more enjoyable. In the father and daughter example, when the father is using the laptop, camera information is utilized to make this determination, resulting in use of the first profile. As a result, the first sensor 104, second sensor 106, and other sensors communicate information to the action type webpage. Consequently, a network AI application provides items the father has shown interest in purchasing in the past. Similarly, if a daughter is utilizing the laptop, the network AI application utilizes the second profile, and provides items the daughter would more likely be interested in purchasing.

In an alternative embodiment, the network resource is a set of smart headphones. The smart headphones again may have a network AI application. When a father is determined as utilizing the smart headphones via information communicated through an electronic device such as a cell phone, laptop, computing device, etc. a news radio station may be provided on the smart headphones, along with a playlist of common songs of the father based on the first profile. Similarly, when the daughter is detected, the smart headphones may simply play a playlist of common songs requested or listened to by the daughter based on the second profile. Smart headphone volume settings may similarly be adjusted depending on whether the first profile is determined or if the second profile is determined.

In a second operating state, information is only shared with the one or more processors 204 of the electronic device 102. In this manner, the information is not shared with the network resources. So, if an individual is paranoid about having information about them shared with third party applications or certain network resources, their profile provides this indication, and the second operating state is utilized. By having the one or more processors 204 receive the information, the electronic device may still provide advantages such as providing common websites or searches of a detected user, providing sound settings at common setting of an identified user, utilize a screen saver or other power saving technique when a user is not detected or sensed utilizing the electronic device, or the like.

In one example, a user may be doing research on a political candidate; however, the user has no desire to have the candidate have information related to them. In this manner, the user may either manually place the first sensor 104 and second sensor 106 in the second operating state, or may provide such an input setting. In this manner, information is not shared with the political website. Then, the AI application 220 may utilize this information as a condition to update the profile of the individual such that any time the individual accesses a political based website, the first sensor 104 and second sensor 106 operate in the second operating state.

In another example, an individual may be traveling to a foreign country and does not trust any network or network resource of that foreign country. Again, when traveling to the country, the second operating state is utilized. In this manner, traveling to the specific foreign country is a condition, and the AI application 220 may set up a first profile for when the individual is outside of the specific foreign country, and a second profile for when the individual is within the specific foreign country.

In yet another example, the operating status may change between the first profile and second profile, and thus the first operating state and the second operating state depending on a user identified. Therefore, if a father is suspicious of sharing information with any network resource, and a daughter is ok with sharing such information, when the father is identified as the user the first profile is utilized and the second operating state is implemented, while when the daughter is detected, a second profile is utilized and the first operating state is implemented. In this manner, the user of the electronic device is the condition present that results in a change of a profile, and/or operating state.

In a third operating state, no information is shared. In one example, a user may simply provide a setting in the communication application 220 where no information is to be shared. When such a setting is provided, in one example a shutter may physically close and cover the first sensor 104, second sensor 106, and any additional sensors. In another example, a user may physically move the shutter from a first position where the first sensor 104 and second sensor 106 can detect information to a second position wherein the first sensor 104 and second sensor 106 cannot detect information. When moved to the second position, the communication application 220 may detect the shutter in the second position and turn off the first sensor 104 and second sensor 106 to reduce wear on the first sensor 104 and second sensor 106. In this manner, if an individual simply does not want to share personal information at all, the third operating state is provided to allow that individual such comfort.

FIG. 3 illustrates a block diagram of a method 300 of controlling communication information. The method 300 may be implemented utilizing the system and electronic device of FIGS. 1 and 2.

At 302, one or more processors obtain a first type of information regarding an environment of interest. The one or more processors may obtain the first type of information from a first sensor, have the information input into the electronic device or the like. The first type of information can include auditory, visual, haptic, infrared, etc. The environment of interest can be a room, a chair, a classroom, a dwelling, a home, an office cubical, an office building, or the like.

At 304, the one or more processors obtain a second type of information regarding an environment of interest. The one or more processors may obtain the second type of information from a second sensor, have the information input into the electronic device or the like. The second type of information can include auditory, visual, haptic, infrared, etc. The environment of interest can be a room, a chair, a classroom, a dwelling, a home, an office cubical, an office building, or the like.

At 306, the one or more processors identify a condition present in the environment of interest based on the first type of information and the second type of information. The condition present in one embodiment is the existence of an individual in front of the electronic device. In other embodiments, the condition present can be the identity of an individual in front of the electronic device, the identity of two or more individuals in the environment of interest, the environment of interest itself in being an office, home, cubical, outdoors, indoors, or the like, the presence of a user, a launching of an application, a voice command, a gesture or movement, etc. In particular, the condition can be utilized to determine the operating state of the first sensor and/or the second sensor.

At 308, one or more processors select a first profile, or second profile based on the condition. The condition is any item that can result in the change of a first profile to a second profile. In one embodiment, the condition is the user of the electronic device. In another embodiment, the condition is a determined age of a user. In yet another embodiment, the condition is the location of the environment of interest, whether in an office, home, inside, outside, etc. In one example, the condition is the launching or use of an application such as Zoom, Webex, Skype, or the like. In another example, the condition is based on the network resource selected, such as when certain content is on an accessed webpage. In yet another example, the condition is based on the location of the electronic device as determined through a global positioning system, or otherwise. In one example, the condition is a manual input provided by a user. In each instance, the condition results in different profile information, and potentially different operating settings.

At 310, a determination is made whether an operating state needs to be changed based on the selected profile. In particular, in some instances, a change from a first profile to a second profile can occur without a change in the operating state of a sensor. For example, when a father has a first profile, and a daughter has a second profile, both may be comfortable with sharing information from sensors with network resources and the local processors. As such, the operating state does not change; however, the profiles do change. In this manner, when the father is detected as utilizing an electronic device, the AI application only applies information obtained related to the father to update the first profile. As such, the information obtained related to the father is not utilized to update the second profile of the daughter. Still, the operating state itself is not changed. Thus, if at 310 a determination is made that operating states do not need to be changed, at 312 the selected profile is implemented.

If at 310, a determination is made that the operating state needs to change based on the selected profile, then at 314 the operating state of the first sensor and/or second sensor are changed consistent with the selected profile. So, in the father daughter example, if the father does not trust providing any information to an electronic device, when the first profile is the father's profile, the one or more processors will shut off the first sensor and the second sensor. In one example, a first status indicator such as a light element is associated with the first sensor while a second status indicator is associated with the second sensor such that both the first status indicator and second indicator do not light when the first sensor and second sensor are turned off. In this manner, the father has visual evidence that no information is being obtained by the first sensor or second sensor that may be shared.

Alternatively, an electronic device may include a shutter that moves from a first position where the first sensor and second sensor are visible to a user to a second position where the first sensor and second sensor are covered and not visible to a user. In this manner, again, the user is assured that the first sensor and second sensor are not saving or sharing information. Then, if the daughter begins using the laptop, and the daughter is comfortable with sharing information with network resources and having her information kept by the one or more processors so the AI application and network AI applications can improve her experience, the operating state is changed. In one example, a first status indicator associated with the first sensor and a second status indicator associated with the second sensor are both status indicators that illuminate to indicate that the first sensor and second sensor are sharing information. Alternatively, a shutter moves from a second position that covers and blocks the first sensor and second sensor to a first position that allows access to the first sensor and second sensor. In this manner, as the shutter moves from the second position to the first position the first sensor and second sensor activate and begin obtaining information.

In other embodiments, a user profile may allow a first sensor to share information with one or more processors of the electronic device, but not share information with network resources while the second sensor does not share information with the one or more processors or network resources. In particular, the first sensor may be an auditory sensor while the second sensor is a camera, and the individual may be comfortable with recording and using auditory information for an AI application, but not image data. To this end, a first profile and a second profile define corresponding combinations of operating states associated with potential conditions that may become present in the environment of interest. The one or more processor may then switch between the first profile and second profile based on the condition present in the environment identified. In this manner, the user has full control over the exact information that is shared, and with what devices the information may be shared. To this end, a first operating state can be a network sharing state in which the first type of information obtained by the first sensor is shared with the network resource through the communications interface. The second operating state can be a local state in which the first type of information is maintained locally on, and is solely accessible to, the one or more processors of the electronic device and is not shared with the network resource. In this manner, only the one or more processors receive the information, and network resources do not receive the information. Meanwhile, the third operating state can be a private state where first type of information is not shared with the network resource or maintained locally on the one or more processors.

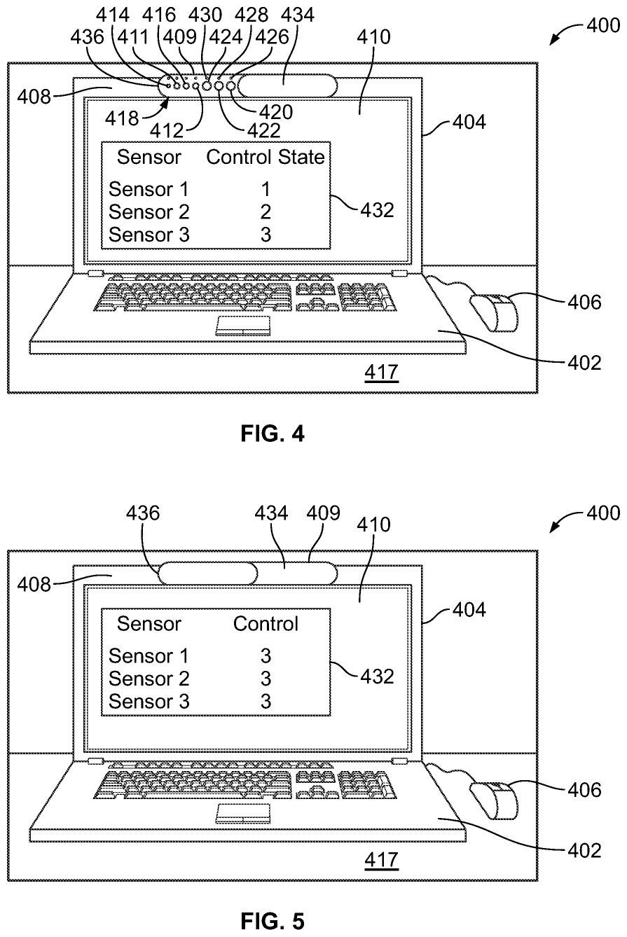

FIGS. 4 and 5 illustrate an example electronic device 400 that is a laptop computer. The electronic device includes a keyboard 402 that is hingedly coupled to a display 404. An input device 406 such as a mouse is coupled either through a cord, such as a USB cord, or wirelessly. In other examples, the keyboard 402 may include a touch pad that functions as a mouse.

The display 404 includes a top bezel 408 that is part of a frame, or area, that forms a border around a screen 410. Along the top bezel 408 is a housing 409 including a sensor mounting panel 411. Within the sensor mounting panel in side-by-side relation are a first sensor 412, a second sensor 414, and a third sensor 416. Specifically, the first sensor, second sensor, and third sensor are each mounted in the housing 409 and oriented to extend through the sensor mounting panel 411 to face an environment of interest. The first sensor 412 collects a first type of information, the second sensor 414 collects a second type of information that is different from the first type of information, while the third sensor 416 collects yet a third type of information different from the first type of information and second type of information. In each instance, each sensor 412, 414, 416 collects information related to and regarding the environment of interest 417.

Disposed adjacent the first sensor 412, second sensor 414, and third sensor 416 within the housing 409 is a capacitive control area 418. The capacitive control area 418 in one example is a capacitive control strip that is electrically coupled to the first sensor 412, second sensor 414, and third sensor 416 to place each sensor in a determined operating state. In one example, the capacitive control strip includes a first actuating button 420 below the first sensor 412, second actuating button 422 below the second sensor 414, and a third actuating button 424 below the third sensor 416. Each actuating button 420, 422, 424 when actuated actuate different operating states of the corresponding sensors 412, 414, 416 respectfully. When actuated a first time, a first operating state is provided that is a network sharing state in which a first type of information obtained by the first sensor is shared with a network resource through the communications interface. When the button is actuated a second time, a second operating state is provided that is a local state in which the first type of information is maintained locally on, and is solely accessible to, the one or more processors of the electronic device and not shared with the network resource. When the button is actuated a third time, a third operating state is provided representing a private state where the first type of information is not shared with the network resource or maintained locally on the one or more processors. In yet another state, the information may be both shared with a network resource and one or more local processors. Thus, depending on the amount of time you actuate an actuating button 420, 422, 424 determines the operating state. In one example, a bar or indicator may be provided for each sensor to visually indicate the operating state of the sensor in question.

In one embodiment, within the housing 409 below the actuating buttons and/or proximate to a corresponding sensor is a first status indicator 426, second status indicator 428, and third status indicator 430. Each of the status indicators 426, 428, and 430 are provided on the housing and designate the operating state of the sensors. In one example each of the first status indicator 426, second status indicator 428, and third status indicator 430 are light elements that in one example are light emitting diodes. In one example, each status indicator is electrically coupled to a corresponding button and sensor such that when the sensor is in an operating state that shares information the respective status indicator 426, 428, 430 emits light, and when a sensor is off, or in a private operating state, the status indicator is off. In this manner a user has a visual indication of whether information obtained by the sensors is being obtained. In one example, sets of status indicators are presented instead of a single status indicator, and depending on the operating state depends on the status indicator in the set of status indicator that emits light. Alternatively, the individual status indicators turn different colors that correspond to the operating state of the corresponding sensor. In each instance, additional information is provided to as user to have knowledge of how information obtained by the sensors is being shared.

In addition to the capacitive control area 418, the electronic device may include a control resource 432 of a communication application that indicates the operation state of each sensor. The control resource 432 allows a user to manually input information regarding themselves to create a profile utilized by the communication application. The input may be provided by typing in information, answering questions, utilizing a mouse or touch screen, etc. Specifically, on the control resource 432, a user may choose the operation state the user desires for each sensor as a setting. To this end, a user may manually change such inputs and settings at any time.

Optionally, a shutter 434 can be coupled to the top bezel 408 and move from a first position (FIG. 4) that allows access to the sensors and actuation buttons to a second position (FIG. 5) that covers the sensors and actuations buttons. The shutter 434 is of size and shape to completely cover each of the sensors. In one example, the shutter 434 may be manually moved from the first position to the second position. In one example, a stop 436 is positioned to stop the shutter in a correct location to allow blocking of each of the sensors. Alternatively, the shutter is electrically coupled to the electronic device such that the shutter 434 is electromechanically moved from the first position to the second position automatically. In another example, magnets may be utilized to move the shutter 434 from the first position to the second position.

In one embodiment, the shutter is electrically coupled to the electronic device and/or sensors such that when the shutter 434 moves from the first position to the second position, the sensors are deactivated to save wear on the sensors. Additionally, when the shutter 434 moves from the second position to the first position, the sensors are activated so that they are ready for use and communication of information.

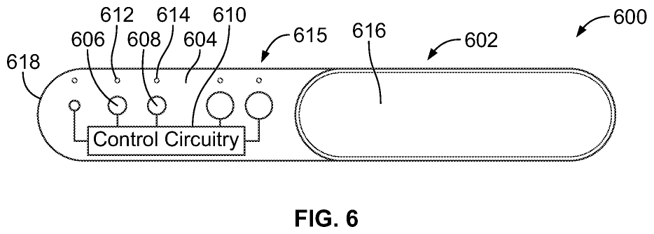

FIG. 6 illustrates an embodiment of a sensor device 600 in accordance with one or more embodiments. In particular, instead of being integrated within an electronic device as illustrated in other Figures, FIG. 6 illustrates a stand-alone sensor device 600 that may be mechanically and electrically coupled to an existing electronic device.

The sensor device 600 includes a housing 602 that has a sensor mounting panel 604. Mounted within the sensor mounting panel 604 are a first sensor 606 and a second sensor 608. The first sensor 606 and second sensor 608 are oriented to extend through the sensor mounting panel 604 to face an environment of interest. Similar as described above, the first sensor 606 collects a first type of information and the second sensor 608 collects a second type of information that is different from the first type of information, regarding the environment of interest. The sensor device 600 also includes sensor control circuitry 610 that changes a current operating state, of the first sensor, between first, second and third operating states. The first operating state represents a network sharing state in which the first type of information collected by the first sensor is shared with a separate network resource. The second operating state representing a local state in which the first type of information is maintained locally on, and is solely accessible to, the electronic device and is not shared with the separate network resource. The third operating state meanwhile representing a private state where the first type of information is not provided to a network resource or one or more local processors.

The first sensor 606 also includes a first status indicator 612 provided on the housing within the sensor mounting panel 604. Similarly, the second sensor 608 includes a second status indicator 614 provided on the housing within the sensor mounting panel 604. As indicated above, the first and second status indicators on example embodiments are light element such as light emitting diodes. Each status indicator 612, 614 designates a current operating state of the first sensor 606 and the second sensor 608. A capacitive control area 615 can also be provided. The capacitive control area 615 in one example is a capacitive control strip that is electrically coupled to the first sensor 606, and second sensor 608 to place each sensor in a determined operating state.

Optionally, the sensor device 600 also includes a shutter 616 that can be mechanically and electrically coupled to the housing and configured to move from a first position that covers the first and second sensors 606, 608 to a second position that uncovers the first and second sensors 606, 608. The shutter 616 operates as described above, either manually, or electromechanically. Additionally, the housing 602 in one example includes a stop 618 the positions the shutter over the first and second sensors 606, 608.

As will be appreciated, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable data storage device(s) having computer (device) readable program code embodied thereon.

Any combination of one or more non-signal computer (device) readable mediums may be utilized. The non-signal medium may be a data storage device. The data storage device may be, for example, an electronic, magnetic, optical, electromagnetic, infrared, or semiconductor system, apparatus, or device, or any suitable combination of the foregoing. More specific examples of a data storage device may include a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface and a storage device for storing code may store the program code for carrying out the operations and provide this code through the network interface via a network to a second device having a second processor for execution of the code on the second device.

Aspects are described herein with reference to the figures, which illustrate example methods, devices and program products according to various example embodiments. These program instructions may be provided to a processor of a general purpose computer, special purpose computer, or other programmable data processing device or information handling device to produce a machine, such that the instructions, which execute via a processor of the device implement the functions/acts specified. The program instructions may also be stored in a device readable medium that can direct a device to function in a particular manner, such that the instructions stored in the device readable medium produce an article of manufacture including instructions which implement the function/act specified. The instructions may also be loaded onto a device to cause a series of operational steps to be performed on the device to produce a device implemented process such that the instructions which execute on the device provide processes for implementing the functions/acts specified.

The units/modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the modules/controllers herein may represent circuit modules that may be implemented as hardware with associated instructions (for example, software stored on a tangible and non-transitory computer readable data storage device, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

1. An electronic device, comprising:
an output to present audio/video (AV) content;
memory to store executable instructions;
a communications interface configured to communicate with a network resource;
a housing including a sensor mounting panel;
first and second sensors mounted in the housing and oriented to extend through the sensor mounting panel to face an environment of interest, the first sensor to collect a first type of information and the second sensor to collect a second type of information that is different from the first type of information, regarding the environment of interest;
one or more processors, when implementing the executable instructions, to:
determine a user profile based on the first type of information or the second type of information;
change an operating state, of the first sensor, between first, second and third operating states;
the first operating state representing a network sharing state in which the first type of information collected by the first sensor is shared with the network resource through the communications interface; and
the second operating state representing a local state in which the first type of information is maintained locally on, and is solely accessible to, the one or more processors of the electronic device and is not shared with the network resource; and
update the user profile based on the change in the operating state.

2. The electronic device of claim 1, wherein the one or more processors are further configured to identify a condition present in the environment of interest based on the first type of information and the second type of information.

3. The electronic device of claim 2, wherein the memory is further configured to store first and second profiles that define corresponding combinations of operating states associated with potential conditions that may become present in the environment of interest, and the one or more processors are further configured to select either the first profile or second profile as the user profile based on the potential conditions.

4. The electronic device of claim 3, wherein the one or more processors are further configured to switch between the first profile being the user profile and second profile being the user profile based on the condition present in the environment identified.

5. The electronic device of claim 1, wherein at least one of the first sensor or the second sensor operates in the first operating state and the second operating state.

6. The electronic device of claim 1, further comprising status indicators provided on the housing, the status indicators to designate the operating state of the first and second sensors.

7. The electronic device of claim 6, wherein the status indicators include a light element that indicates the operating state of the first and second sensors.

8. (canceled)

9. The electronic device of claim 1, wherein the one or more processors are further configured to display on the output a control resource; and
determine the operating state based on a user input to the control resource.

10. The electronic device of claim 1, further comprising a shutter coupled to the housing and configured to move from a first position that covers the first and second sensors to a second position that uncovers the first and second sensors.

11. The electronic device of claim 10, wherein the one or more processors are further configured to deactivate the first and second sensors when the shutter is placed in the first position, and activate the first and second sensors when the shutter is placed in the second position.

12. A method, comprising:
under control of one or more processors including program instructions to:
obtain, with a first sensor, a first type of information regarding an environment of interest;
obtain, with a second sensor, a second type of information regarding the environment of interest that is different than the first type of information;
determine a user profile based on the first type of information or the second type of information;
change an operating state, of the first sensor, between first, second and third operating states;
the first operating state representing a network sharing state in which the first type of information obtained by the first sensor is shared with the network resource through the communications interface;
the second operating state representing a local state in which the first type of information is maintained locally on, and is solely accessible to, the one or more processors of the electronic device and is not shared with the network resource;
the third operating state representing a private state where first type of information is not shared with the network resource or maintained locally on a memory; and
update the user profile based on the change in the operating state.

13. The method of claim 12, wherein the one or more processors further include program instructions to:
identify a condition present in the environment of interest based on the first type of information and the second type of information.

14. The method of claim 13, wherein the one or more processors further include program instructions to select the user profile from a first profile or second profile based on the condition;
wherein the first profile and the second profile define corresponding combinations of operating states associated with potential conditions that may become present in the environment of interest.

15. The method of claim 14, wherein the one or more processors further include program instructions to switch the user profile between the first profile and second profile based on the condition present in the environment identified.

16. The method of claim 12, wherein the one or more processors further include program instructions to operate at least one of the first sensor or the second sensor in the first operating state and the second operating state.

17. The method of claim 12, wherein the one or more processors further include program instructions to:
move a shutter from a first position that covers the first sensor and the second sensor, to a second position that uncovers the first sensor and the second sensor;
deactivate the first sensor and the second sensor when the shutter is in the first position; and
activate the first sensor and the second sensor when the shutter is in the second position.

18. A sensor device, comprising:
a housing including a sensor mounting panel;
first and second sensors mounted in the housing and oriented to extend through the sensor mounting panel to face an environment of interest, the first sensor to collect a first type of information and the second sensor to collect a second type of information that is different from the first type of information, regarding the environment of interest;
sensor control circuitry to change a current operating state, of the first sensor, between first, second and third operating states;
one or more processors, when implementing the executable instructions, to:
determine a user profile based on the first type of information or the second type of information;
change an operating state, of the first sensor, between first, second and third operating states;
the first operating state representing a network sharing state in which the first type of information collected by the first sensor is shared with a separate network resource,
the second operating state representing a local state in which the first type of information is maintained locally on, and is solely accessible to, the electronic device and is not shared with the separate network resource; and
update the user profile based on the change in the operating state.

19. The sensor device of claim 18, further comprising status indicators provided on the housing, the status indicators to designate a current operating state of the first sensor and the second sensor.

20. The sensor device of claim 18, further comprising a shutter coupled to the housing and configured to move from a first position that covers the first and second sensors to a second position that uncovers the first and second sensors.

21. The electronic device of claim 2, wherein a manual change in the operating state is the condition present in the environment of interest.
